(19) United States
(12) Patent Application Publication
(10) Pub. No.: US 2026/0192927 A1
(43) Pub. Date: Jul. 9, 2026

(54) COMPOSITE BATTERY LEADING EDGE ICE PROTECTION

(71) Applicant: Textron Aviation, Inc., Wichita, KS (US)

(72) Inventors: Kyle Dietz Tidball, Wichita, KS (US); Vernon Weng-Yew Chang, Wichita, KS (US); Amit A. Tamhane, Wichita, KS (US); Engin Sabuncu, Wichita, KS (US)

(21) Appl. No.: 19/014,663

(22) Filed: Jan. 9, 2025

(51) Int. Cl. B64D 15/12; B64D 27/357; H01M 10/42; H01M 10/46; H01M 10/48; H01M 10/615; H01M 10/625; H01M 10/637; H01M 50/204; H01M 50/249; H01M 50/509

(52) U.S. Cl. CPC B64D 15/12; B64D 27/357; H01M 10/425; H01M 10/46; H01M 10/482; H01M 10/486; H01M 10/615; H01M 10/625; H01M 10/637; H01M 50/204; H01M 50/249; H01M 50/509; H01M 2010/4271; H01M 2010/4278; H01M 2220/20

(57) ABSTRACT

An ice protection system, including a first multifunctional composite (MFC) battery cell disposed at an exterior surface of a vehicle, a second MFC battery cell disposed at the exterior surface, a switching system connected to the first MFC battery cell and the second MFC battery cell, and at least one controller, configured for performing first switching control by controlling the switching system to connect the first MFC battery cell to the second MFC battery cell in an arrangement causing the first MFC battery cell to discharge by charging the second MFC battery cell, where the first MFC battery cell discharging by charging the second MFC battery cell heats the exterior surface and at least one of melts an ice accretion on the exterior surface or prevents accretion of ice on the exterior surface.

### TECHNICAL FIELD

The present invention relates generally to a system and method for providing multifunctional composite batteries for ice protection, and, in particular embodiments, to a system and method for providing composite battery structures in vehicle exterior surfaces and using charge and discharge cycles of the batteries for melting accumulated ice on the surfaces.

### BACKGROUND

A major concern with aircraft flying at high altitudes in inclement weather is icing on exterior surfaces such as wings and tail elements. Icing on the exterior surfaces tends to alter the flow of air over the exterior surfaces, while increasing weight and decreasing performance. Thus, may aircraft include ice protection systems to remove or melt ice on the critical surfaces. Traditionally, aircraft ice protection systems have used engine bleed-air and vacuum or pneumatic powered boots to remove or melt ice that accumulates on the aircraft exterior surfaces, such as wings, during flight. However, using bleed air from engines requires substantial ducting, and providing adequate bleed air may negatively affect engine performance. Recently, ice protection systems have shifted from traditional methods to electrothermal ice protection systems. For example, some newer aircraft use a “bleedless” aircraft design, using only electrothermal ice protection, such as electrical heating elements or blankets, for the wings and tail. While this bleedless system saves a considerable amount of weight, and consequently increases fuel efficiency of the aircraft, the bleedless systems increase complexity of the ice protection system. Additionally, bleedless systems allow the omission of bleed air extraction elements from the airframe, reducing airframe weight. The bleedless system also avoids the reduction in engine thrust power, and operates more efficiently than a bleed-type system since the electrical power extraction via engine generator gearbox is more efficient than bleeding air from a running engine.

### SUMMARY

An ice protection system, including at least one first multifunctional composite (MFC) battery cell disposed at an exterior surface of a vehicle, at least one second MFC battery cell disposed at the exterior surface, a switching system connected to the at least one first MFC battery cell and the at least one second MFC battery cell, and at least one controller, configured for performing first switching control by controlling the switching system to connect the at least one first MFC battery cell to the at least one second MFC battery cell in an arrangement causing the at least one first MFC battery cell to discharge by charging the at least one second MFC battery cell, where the at least one first MFC battery cell discharging by charging the at least one second MFC battery cell heats the exterior surface and at least one of melts an ice accretion on the exterior surface or prevents accretion of ice on the exterior surface.

An embodiment ice protection method includes performing, by a controller, first switching control by controlling a switching system to connect at least one first multifunction composite (MFC) battery cell to at least one second MFC battery cell in an arrangement causing the at least one first MFC battery cell to discharge by charging the at least one second MFC battery cell, where the at least one first battery is disposed adjacent to an exterior surface of a vehicle, where the at least one second MFC battery cell is disposed adjacent to the at least one first MFC battery cell and adjacent to the exterior surface, where the at least one first MFC battery cell discharging by charging the at least one second MFC battery cell heats the exterior surface by transferring, to the exterior surface, heat generated in a body of the at least one first MFC battery cell or the at least one second MFC battery cell as a result of the discharging or charging, where the transferring the heat at least one of melts an ice accretion on the exterior surface or prevents accretion of ice on the exterior surface.

An embodiment system includes an ice protection system disposed at a vehicle exterior surface, the ice protection system including a plurality of first a multifunction composite (MFC) battery cell disposed adjacent to an exterior surface of the vehicle exterior surface,, a plurality of second MFC battery cells disposed adjacent to the exterior surface, where the second MFC battery cells of the plurality of second MFC battery cells are each an MFC, where the first MFC battery cells are disposed in a stack, along a leading edge of the vehicle exterior surface, alternating with the second MFC battery cells, and with an arrangement direction that is substantially parallel to the leading edge, and a switching system connected to each of the first MFC battery cells and to each of the second MFC battery cells, where the switching system has first circuitry adapted to connect, in response to at least one first control signal, the first MFC battery cells to the second MFC battery cells in a first arrangement causing the first MFC battery cells to discharge by charging the second MFC battery cells, where the first MFC battery cells discharging by charging the second MFC battery cells heat the exterior surface to provide the ice protection, and where the switching system further has second circuitry adapted to switch, in response to at least one second control signal, the first MFC battery cells and the second MFC battery cells from being connected in the first arrangement to being connected in a second arrangement causing the second MFC battery cells to discharge by charging the first MFC battery cells, where the second MFC battery cells discharging by charging the first MFC battery cells heat the exterior surface to further provide the ice protection.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1B are cutaway views illustrating leading edge ice protection systems according to some embodiments;

FIGS. 2A-2H are cutaway views illustrating battery arrangements for ice protection systems according to some embodiments;

FIGS. 3A-3D are logical diagrams illustrating circuit arrangements for ice protection systems according to some embodiments;

FIG. 4 is a logical diagram illustrating an ice protection circuit according to some embodiments; and

FIG. 5 is a flow diagrams illustrating a method for using ice protection systems according to some embodiments.

### DETAILED DESCRIPTION OF ILLUSTRATIVE EMBODIMENTS

Embodiments of the principles presented herein provide for electrothermal ice protection system using multifunctional composite (MFC) batteries to decrease the complexity of the system, while retaining many of the benefits of electrothermal ice protection. The use of an MFC battery permits implementation of an ice protection system using well understood battery production techniques while providing for ice protection and reduction of production costs and overall structure complexity.

A surface that needs to be protected from ice accretion, such as a wing leading edge, can be constructed out of composite materials, metal-bond, a combination of composite material and metal-bond structures, or another structural element. An array of multifunctional composite battery cells may be formed in the leading edge by one or more stackups of the composite layers themselves. Using a high energy density battery permits greater energy availability for use during ice protection operation within a limited area of a de-ice zone. Some battery chemistries, for example Lithium Nickel Manganese Cobalt, or Lithium Nickel Manganese Oxide, typically produce heat when charged or discharged rapidly, and the excess heat generated by the charge or discharge cycles may be advantageously used to heat the relevant exterior surfaces in the de-ice zones. However, the chemistry of the batteries themselves may be adjusted to align with design objectives, weight requirements, production limitations, heat generation requirements, and the like.

When used in applications that may produce rapid charging or discharging, some batteries must be cooled. However, the heat produced may be advantageously used to melt or prevent ice accretion in the de-ice zones. Constructing and integrating the battery into the leading-edge structure permits efficient heat transfer from the battery to the relevant exterior surfaces. Charging and discharging MFC batteries in the leading edge structure at a reasonably high rate produces heat that is efficiently transferred to the vehicle exterior surfaces. Additionally, constructing the batteries in a multifunctional composite or MFC manner permits specific heat transfer layers to be included in the stackup to assist in transferring heat from the inside of the cell to the leading edge surfaces.

The MFC battery system used as ice protection avoids the need for hot air from the engine bleed system, substantial electrical power from the power generation system, or other requirements detrimental system to performance. The MFC battery system also avoids other system requirements that may include additional weight or space considerations such as bleed air ducting, heater mats, or the like. The system described herein may have multifunctional composite battery integrated into a surface to be protected from ice, and a controller. Active use of the MFC battery ice protection system provides electrothermal ice protection without requiring substantial power from the aircraft generators. In some embodiments, the system features MFC batteries incorporated into the leading-edge of an external aircraft surface, and may use multiple, interleaved batteries to create ice protection zones in the MFC leading edge, shuttling charge back and forth between zones at a high rate to produce heat to melt or prevent ice accretion. Matrixing various groups of one or more batteries together provides higher charging voltage without requiring any power draw, for a limited time, from aircraft power systems. Incorporation of a highly thermally conductive element in the MFC stackup may be used to increase heat transfer efficiency to the leading edge surface. Additionally, a controller, comprising hardware, software or a combination of hardware and software, may be used, in some embodiments, to enable and disable charging of each group of batteries, and control the matrixing of the batteries to control the charge and discharge rates of the different batteries, efficiently controlling the amount of heat delivered to the leading edge surface. Controlling the power density may, in some embodiments, be accomplished by changing the construction of the MFC stackup.

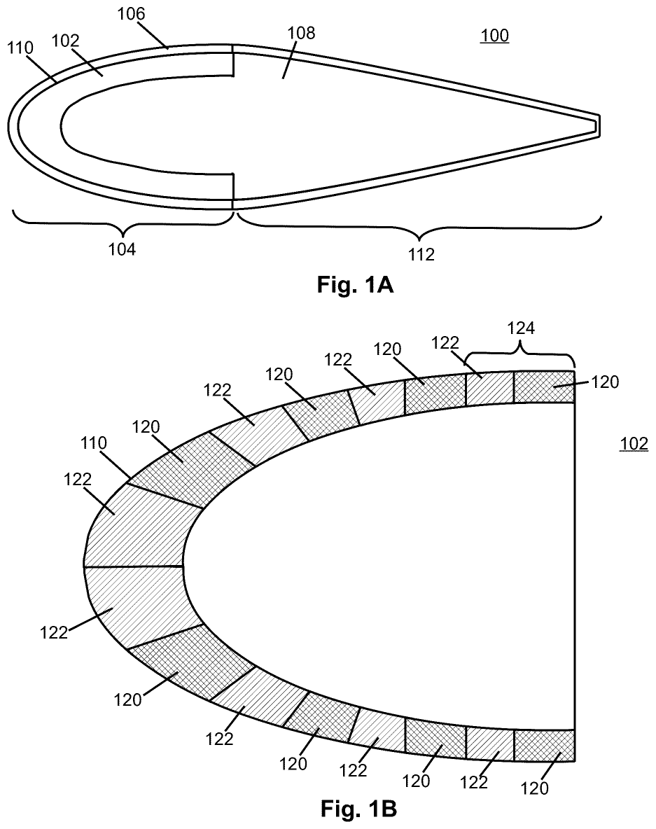

FIGS. 1A-1B are cutaway views illustrating leading edge ice protection systems according to some embodiments. FIG. 1A is a cutaway view illustrating an arrangement of an ice protection system 102 according to some embodiments. A vehicle structure 100 such as an airfoil or stabilizer may include an interior section 108 with an outer surface 106 forming a leading edge 110 of a leading edge section 104. In some embodiments, the ice protection system 102 may be disposed in the leading edge section 104, and a trailing edge section 112 may be free of the ice protection system 102 to reduce weight where ice accretion is not a concern.

A vehicle structure 100 may be an airfoil or stabilizer such as a wing, a tail surface such as a horizontal or vertical stabilizer, a canard, leading edge slat, or the like. In some embodiments, one or more MFC battery cells may be used in an ice protection system 102 to heat a leading edge 110 to melt or prevent ice accretion. The MFC batteries may be charged and discharged to generate heat that is transferred to the outer surface, particularly at the leading edge 110.

FIG. 1B is a cutaway view illustrating an ice protection system 102 with multiple batteries 120, 122 according to some embodiments. In a system where there are n batteries in the ice protection system 102, the ice protection system 102 may include a first group of batteries 120 that have x batteries of the n batteries, and a second group of batteries 122 with y batteries of the n batteries, where n=x+y. The first group of batteries 120 may have individual battery cells arranged with a placement that alternates with placement of battery cells of the second group of batteries 122. The batteries 120, 122 may be arranged along the leading edge 110, along a direction that substantially follows the shape of the leading edge 110. Additionally, the first group of batteries 120 and the second group of batteries 122 may form the contour of the leading edge 110.

During system operation, the second group of batteries 122 are charged by discharging the first group of batteries 120. Once the second group of batteries 122 are charged, and the first group of batteries 120 are discharged, the process reverses. The charged second group of batteries 122 discharge into the depleted first group of batteries 120. This process may be repeated until the bulk of the energy has been dissipated as heat and the highest voltage of any single battery 120, 122 falls below a threshold, after which the batteries 120, 122 may be charged from an external source such as an aircraft generator or external power system, or the like. This continuous charging and discharging process generates a large amount of heat that may be transferred to the leading edge 110 or outside surface and used to melt or prevent ice accretion. In some embodiments, the batteries 120, 122 constructed in the leading edge 110 can be structured such that they are arranged in effective ice shed “zones” 124 with the first batteries 120 and second batteries 122 interleaved or alternating in a longitudinal direction. Thus, the first batteries 120 and second batteries 122 may be alternatingly placed from a front of a leading edge 110 of the wing to the trailing edge of the wing.

In some embodiments, groupings that each have one or more first batteries 120 and one or more second batteries 122 are placed from the front of the leading edge to the back of the ice shed zone, and these groupings may be in tandem on the top and bottom of the structure. This allows the operation of a single zone on each side at a time, with a grouping on the top and a grouping on the bottom operating together. This causes ice to melt, run back and refreeze. Then a pair of groupings in the next zone further aft is energized, repeating the process. This has the effect of stepping the ice accretion aft of the leading edge, where it is eventually shed toward the aft of the surface. In some embodiments, controlling the system in this way permits forwardmost zone to avoid performing an anti-ice function, whereby the edge is kept at about 100 C, with the system functioning in a de-ice mode. Additionally, in some embodiments, the entire system avoids keeping any particular zone constantly hot, and energizes different zones periodically to re-melt ice accretion and cause runback.

This method of shuttling the ice back from the leading edge 110 uses considerably less energy than attempting to completely melt the ice and boil all liquid water, (for example, a system in “anti-ice” mode compared to “de-ice” mode).

Additionally, while the MFC batteries 120, 122 are shown as alternating in a longitudinal direction from the leading edge of a wing to a trailing edge of the wing, the arrangement of batteries is not limited to such an arrangement. For example, leading edges constructed from MFC batteries may be arranged in banks, or may be arranged alternating in a lateral direction from root to tip of the flight surface 100.

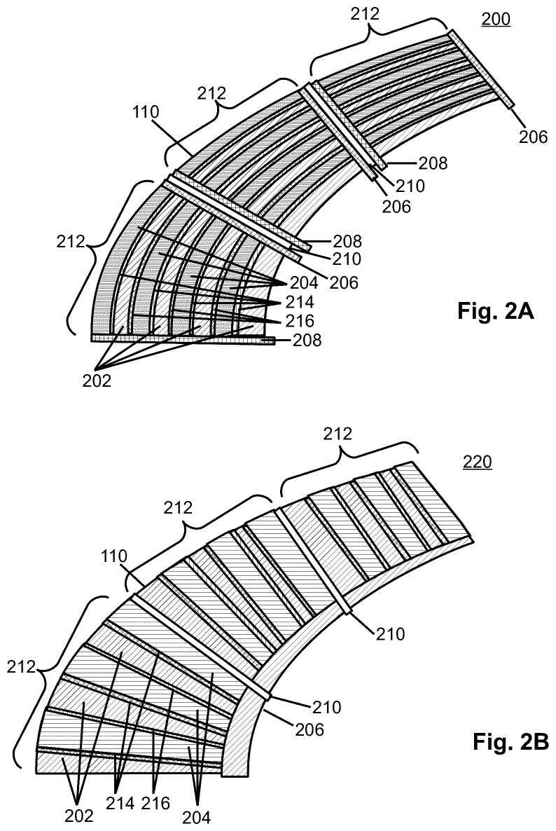

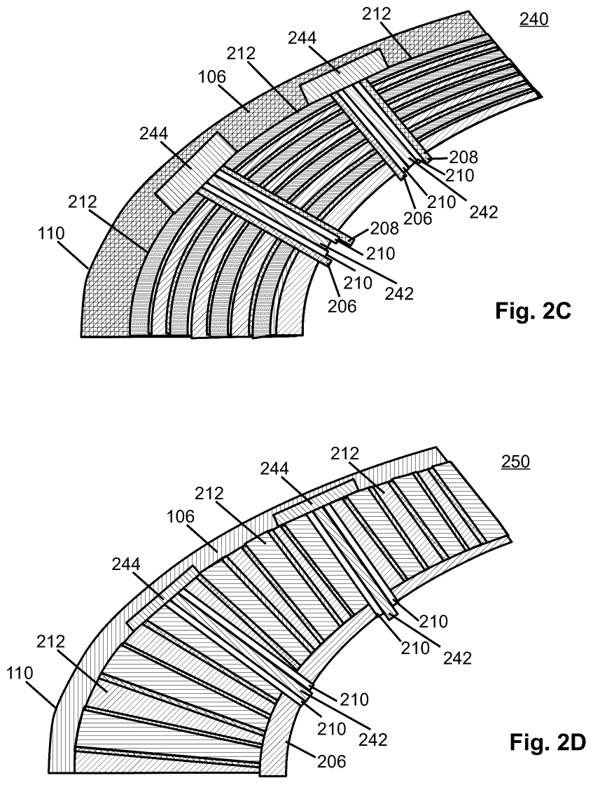

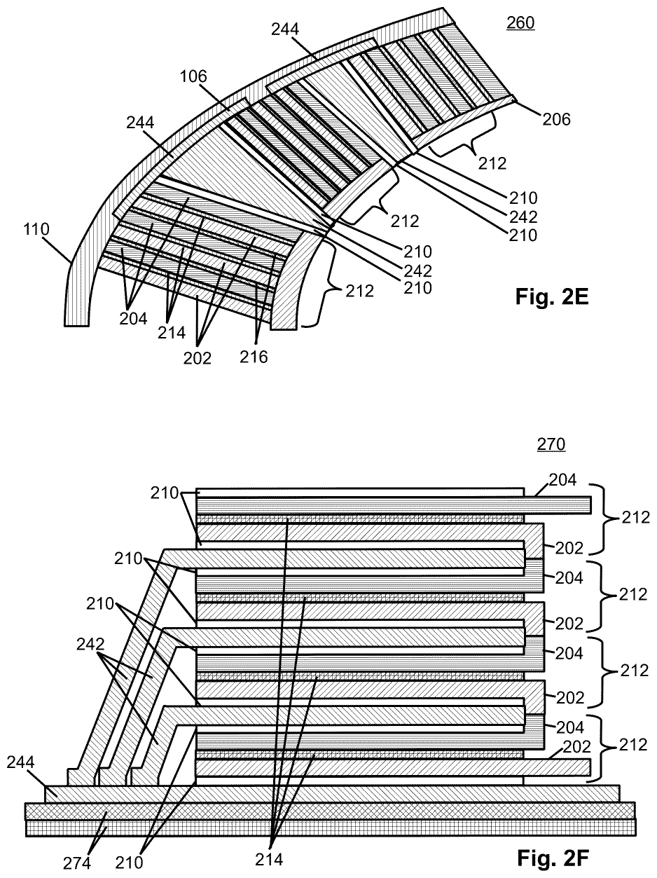

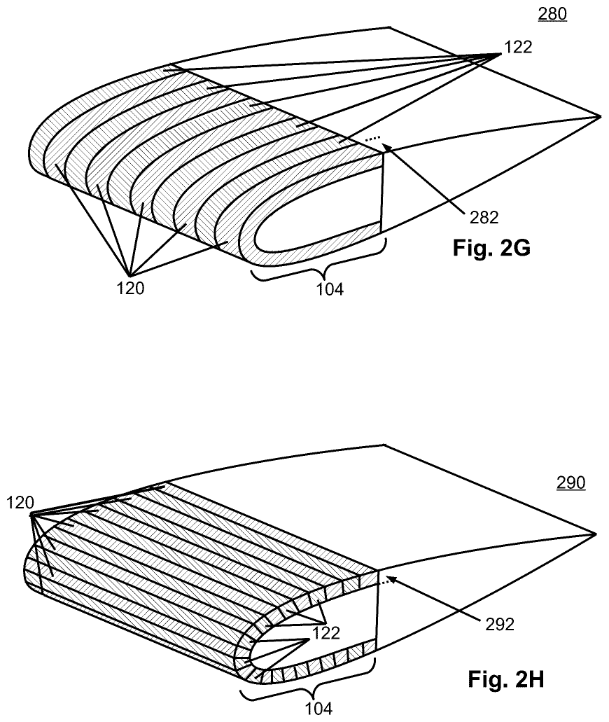

FIGS. 2A-2F are cutaway views illustrating battery 212 arrangements for ice protection systems according to some embodiments. FIG. 2A is a cutaway view of a section of an ice protection system with batteries 212 formed with shaped electrodes 202, 204 according to some embodiments. In such an embodiment, first electrodes 202 and second electrodes 204 are alternatingly layered to form an electrode stack for a battery 212, with the electrode stack having electrodes 202, 204 in layers that follow the curve of the leading edge 110, and with an arrangement direction that extends away from the leading edge surface in the region of the respective battery 212. The first electrodes 202 and second electrode 204 may be separated by a separator layer 214 or other ion transfer layer. Additionally, pairs of first and second electrodes 202, 204 may be separated by insulator layers 216 to electrically isolate cells of a battery 212.

The electrodes 202, 204 in each battery 212 may be electrically connected to each other by terminals 206, 208, and in some embodiments, may be separated by a film, separator layer, electrolyte layer, electrolyte, or other structure or material for ion transfer between the first electrodes 202 and the second electrodes 204. For example, the first electrodes 202 may be cathodes, and may be connected by a first terminal 206, while the second electrodes 204 may be anodes, and may be connected to each other by a second terminal 208. Alternatively, the first electrodes 202 may be anodes, and the second electrodes 204 may be cathodes, depending on the design of the batteries 212, and design requirements of the exterior surface. Additionally, while not shown, the electrode stack may have heat transfer elements that extend from within the battery 212 to outside of the battery to improve heat transfer.

Using arcuate shaped electrodes 202, 204 may permit the batteries to be formed as part of the leading edge production process, and may be incorporated in composite or laminate leading edge construction. As the batteries are MFCs, the layers in the batteries may be laid up during the lamination process by laying the electrodes 202, 204 on a core, inside a mold, or as part of a vacuum bagging process. In some embodiments, the batteries may be pre-formed, and then built into the wing. In some embodiments, the batteries 212 may be separated by insulating elements 210.

FIG. 2B is a cutaway view of a section of an ice protection system with batteries 212 formed with electrodes 202, 204 according to some embodiments. In such an arrangement, the electrodes 202, 204 may be stacked with an arrangement direction that substantially follows the leading edge 110. Thus, the electrodes 202, 204 may extend away from the leading edge 110, and may, in some embodiments, may be separated by a film, separator layer 214, electrolyte layer, electrolyte, or other structure or material for ion transfer between the first electrodes 202 and the second electrodes 204. Additionally, pairs of first and second electrodes 202, 204 may be separated by insulator layers 216 to electrically isolate cells of a battery 212. In some embodiments, different batteries may be separated by insulating elements 210, and may have terminals 206, 208 (not shown) disposed on an inside surface of the batteries 212. While not shown, both a first terminal 206 and a second terminal 208 may be disposed on the interior surfaces of the batteries 212 to permit connection of first electrodes 202 or second electrodes 204 to each other.

In some embodiments, the batteries 212 using the electrodes 202, 204 may be pre-formed or constructed prior to be integrated into the leading edge surface. However, the electrodes 202, 204 are not limited to such an arrangement. While the electrodes 202, 204 in each battery 212 are shown as being slightly wedge shaped, it should be understood that each electrode 202, 204 within a battery 212 may be substantially a constant thickness, and the batteries 212 may be shaped to follow the contour of the leading edge 110 by providing wedge shaped insulating elements 210 or other structural or support elements.

FIG. 2C is a cutaway view of a section of an ice protection system arrangement 240 with batteries 212 formed with shaped or arcuate electrodes 202, 204 and heat transfer elements 242, 244 according to some embodiments. FIG. 2D is a cutaway view of a section of an ice protection system arrangement 250 with batteries 212 formed with electrodes 202, 204 and heat transfer elements 242, 244 according to some embodiments. In some ice protection embodiments, one or more heat transfer elements 242, 244 may be disposed in the MFC stackup, for example, between batteries 212, or between electrodes in a battery 212, and may be arranged to provide for thermal transfer from the interior of the batteries 212 to an outer surface of the leading edge 110. For example, the heat transfer elements 212, 244 may be copper, aluminum, titanium, a polymer, or another material with high thermal conductivity. The heat transfer elements 242, 244 extend from within the MFC stackup to an edge or outer portion of the batteries. In some embodiments, a first heat transfer element 242 extends between the batteries 212, and a second heat transfer element 244 contacts an outer surface 106 such as an aluminum skin or other outer surface. In some embodiments, the first heat transfer element 242 and second heat transfer element are formed as a single piece. The first heat transfer element 242 provides a path for heat to transfer to the edge of the batteries 212, and the second heat transfer element 244 may provide for contact between a heat absorbing surface such as the outer surface 106 the first heat transfer element 242. In other embodiments one or more additional heat transfer elements may be formed within a battery 212, between electrodes 202, 204, and may extend to an outer surface or another heat transfer element 242, 244 to transfer heat from within the battery 212.

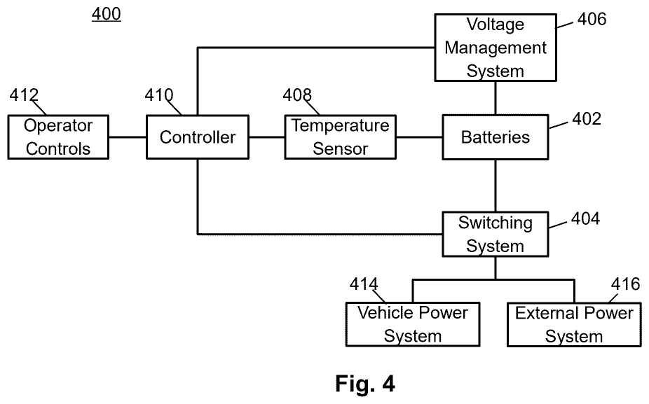

Additionally, while not shown, the MFC stackup of the batteries 212 may include other features such as sensors, or the like. In some embodiments, temperature sensors may be disposed in or at each battery 212, and in some embodiments, temperature sensors may be disposed at or near the outer surface 106 of the leading edge surface. A controller (not shown, see element 410 of FIG. 4) may monitor temperatures to modulate the charging or voltage or charging current to prevent overheating of the batteries, or to ensure that the batteries generate sufficient heat to effectively melt or prevent ice accretions. In some embodiments, the controller may monitor the temperature at the outer surface of the leading edge based on signals indicating the temperature at the batteries or the outer surface 106 according to a signal from temperature at, or near, the outer surface to, for example, modulate the heat generated by the batteries to achieve a target temperature of the outer surface 106, or to automatically turn the ice protection system on or off when the temperature of the outer leading edge surface 106 falls above or below a threshold, or the like.

FIG. 2E is a cutaway view of a section of an ice protection system arrangement 260 with batteries 212 formed with electrodes 202, 204 with constant thickness and heat transfer elements 242, 244 according to some embodiments. The first electrodes 202 and second electrode 204 may be separated by a separator layer 214 or other ion transfer layer. Additionally, pairs of first and second electrodes 202, 204 may be separated by insulator layers 216 to electrically isolate cells of a battery 212. In some ice protection embodiments, the first electrodes 202 may have a substantially constant or uniform thickness, and the second electrodes 204 may each have a substantially constant or uniform thickness. In some embodiments, one of more portions of the heat transfer elements 242, 244 or insulating elements 210 may be shaped to fill space between batteries 212 so that the batteries 212 are arranged immediately adjacent to the leading edge 110.

FIG. 2F is a cutaway view of a section of an ice protection system arrangement 270 with batteries 212 stacked on exterior structures 274 and with multiple heat transfer structures 242, 244 according to some embodiments. In some ice protection embodiments, the first multiple batteries 212, cells or other battery segments may be stacked in an arrangement direction extends away from an exterior surface or exterior structures 274, such as an exterior vehicle skin, shell, or the like. Each battery 212 may have a first electrode 202 and second electrode 204 separated by a separator layer 214 or other ion transfer layer, and may be insulated from adjacent batteries 212 by insulating elements 210. In some embodiments, the batteries 212 may be electrically connected in series to provide a higher voltage than a single battery 212.

The system may have multiple first heat transfer elements 242 that are disposed between or extend between the batteries 212, or between electrodes of a battery 212, and that connect to a second heat transfer element 244. The first electrode elements 242 may extend from within the stack of batteries 212, past one or more batteries, to the second heat transfer element 244. In some embodiments, the first heat transfer elements 242 provide heat transfer from the bodies of the batteries 212 to the second heat transfer element to heat the exterior 274 structures for ice melting and ice accretion prevention.

FIG. 2G is a cutaway view of a section of an ice protection system arrangement 280 with batteries 120, 122 alternating laterally along the leading edge section according to some embodiments. In some embodiments, the leading edge section 104 has first batteries 120 alternating with second batteries 122 in an arrangement direction that extends along, or parallel to the leading edge of the wing. In some embodiments, the batteries 120, 122 may have substantially equal widths 282, sizes or volumes so that each battery 120, 122 has about the same capacity, and so that a controller or other charging control mechanism does not track the charge state of individual batteries and may treat each battery 120, 122 the same for charging and discharging. In other embodiments, for example, in a tapered wing, the widths 282 of the batteries 120, 122 may vary as the height or depth of a battery 120, 122 or battery section changes so that the volume and associated storage capacity of each battery 120, 122 is substantially the same. In yet other embodiments, the capacities of one or more of the batteries may be different due for example, to different dimensions or different volumes, and a controller may tack the charge state of each battery individually, and may connect batteries in a configuration that balances charging of each battery 120, 122 or may control the charging rate or duration of individual batteries 120, 122 to ensure that each battery is property charged or discharged.

FIG. 2H is a cutaway view of a section of an ice protection system arrangement 290 with batteries 120, 122 alternating longitudinally from the leading edge section toward the trailing edge according to some embodiments. In some embodiments, the leading edge section 104 has first batteries 120 alternating with second batteries 122 in an arrangement direction that extends away from the leading edge of the wing, or that is perpendicular to a long axis of the wing or to the leading edge of the wing. In some embodiments, the batteries 120, 122 may have substantially equal thicknesses 292, widths, sizes or volumes so that each battery 120, 122 has about the same capacity. Similar to the arrangement described above, the dimensions of the batteries 120, 122 may be varied to result in substantially the same capacity for each battery 120, 122, or the volume may be varied, and a controller may control charging and discharging to ensure proper management of each battery 120, 122. Thus, batteries 120, 122 may be fitted to a contour, and in some embodiments, may be square or rectangular in cross section, and may have filler sections between the batteries 120, 122 to account for the curvature of the surface along which the batteries 120, 122 are disposed.

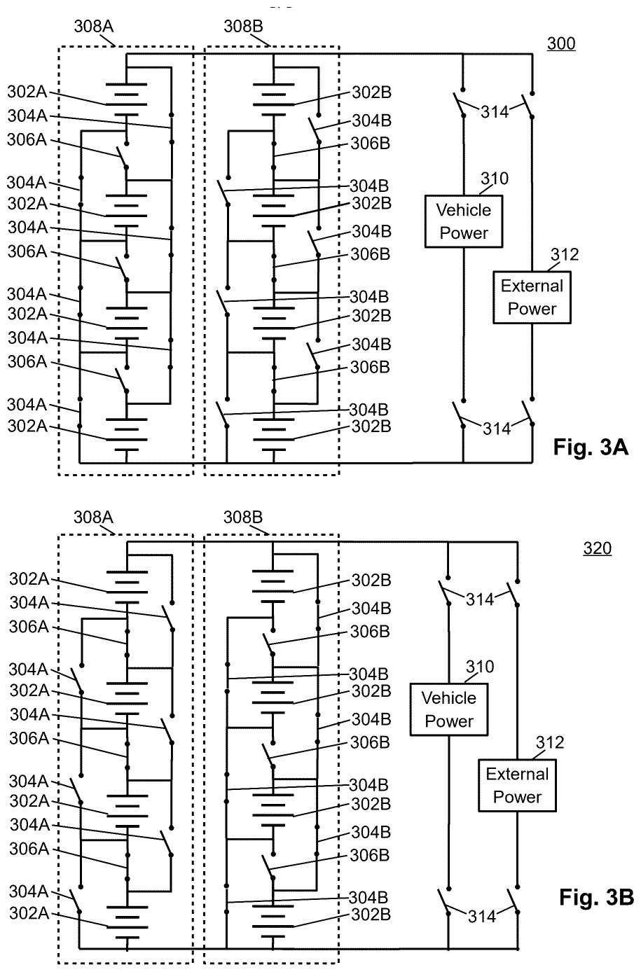

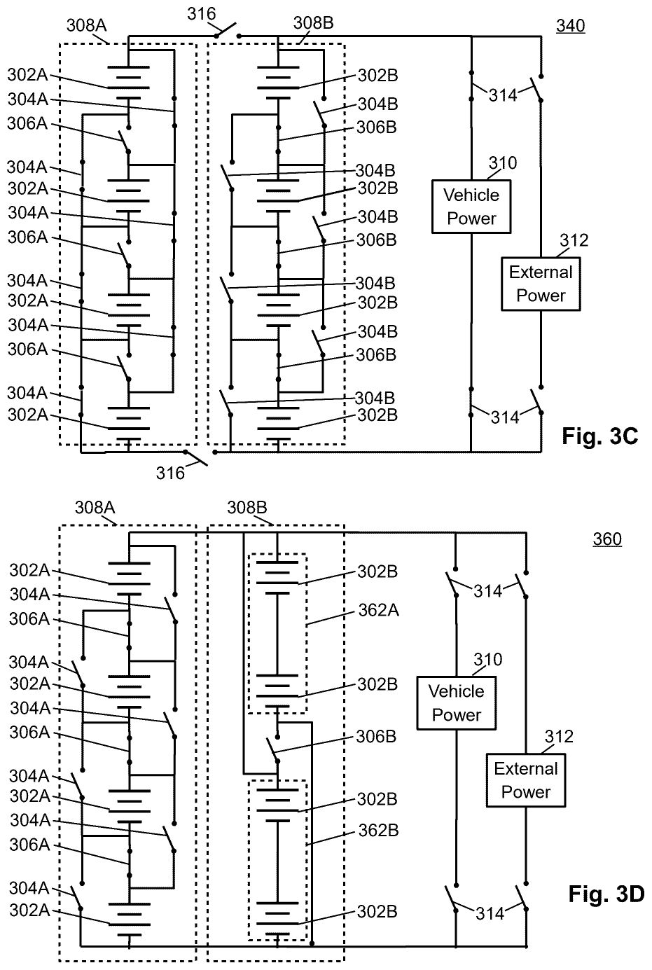

FIGS. 3A-3D are logical diagrams illustrating circuit arrangements for MFC leading edge-based ice protection systems according to some embodiments. FIG. 3A is a logical diagram illustrating an ice protection circuit arrangement 300 with second batteries 302B connected in a higher voltage series configuration to charge first batteries 302A connected in a lower voltage parallel configuration according to some embodiments. The ice protection circuit arrangement 300 shown illustrates an example of a second battery bank 308B having a higher voltage than a first battery bank 308A with batteries connected in parallel.

In order to transfer the most energy possible between batteries 302A, 302B, multiple zones along the surface may be combined in series or parallel as battery banks 308A and 308B. The voltage for charging each battery bank 308B must be higher than the voltage of the battery bank 308A being charged. Therefore, multiple batteries 302A, 302B may be combined in series to raise the charging voltage. For example, the second batteries 302B may be connected in series, while the first batteries 302A are connected in parallel, with the second batteries' 302B series configuration causing the second battery bank 308B to have a voltage higher than the voltage of the first battery bank 308A. However, in order to keep the internal battery temperature from reaching unacceptably high levels that could lead to battery failure, a controller may modulate the charging voltage to keep the temperature of the battery charging within a window. Keeping the battery temperatures within a window ensures that the temperatures remain elevated enough to avoid lithium plating during fast charging, yet do not exceed a dangerously high temperature leading to internal damage to the cells. The heat generated during charging will be extracted and used for the purpose of ice protection, so high temperature and high thermal transfer is desirable.

In some embodiments, the ice protection circuit may have a first battery bank 308A with one or more first batteries 302A with one or more first series switches 306A that are configured to selectively connect the first batteries 302A in series. Additionally, the first battery bank 308A may have one or more first parallel switches 304A that are configured to selectively connect the first batteries 302A in parallel.

In some embodiments, each first series switch 306A selectively connects a positive end of a first battery 302A to a negative end of another first battery 302A under control of one or more controllers (not shown, see element 410 of FIG. 4). Each of the first parallel switches 304A is configured to connect either a positive terminal of one of the first batteries 302A to one or more positive terminals of other first batteries 302A or a negative terminal of one of the first batteries 302A to one or more negative terminals of other first batteries. The first parallel switches 304A may also be operated under control of the controllers, with the controller connecting the first batteries 302A to be in parallel for charging by the second battery bank 308B, or in series to provide charging for the second battery bank 308B.

Similarly, in some embodiments, the ice protection circuit may have a second battery bank 308B with one or more second batteries 302B with one or more second series switches 306B that are configured to selectively connect the second batteries 302B in series. Additionally, the second battery bank 308B may have one or more second parallel switches 304B that are configured to selectively connect the second batteries 302B in parallel.

In some embodiments, each second series switch 306B selectively connects a positive end of a second battery 302B to a negative end of another second battery 302B under control of one or more controllers. Each of the second parallel switches 304B is configured to connect either a positive terminal of one of the second batteries 302B to one or more positive terminals of other second batteries 302B or a negative terminal of one of the second batteries 302B to one or more negative terminals of other second batteries 302B. The second parallel switches 304B may also be operated under control of the controllers, with the controller setting the first batteries 302A to be in parallel for charging by the second battery bank 308B while the second batteries 302B are connected in series.

Additionally, in some embodiments, the ice protection circuit may include charging switches 314 for selectively connecting the first battery bank 308A or second battery bank 308B to a vehicle power system 310 or to an external power system 312. In some embodiments, the vehicle power system 310 or external power system 312 may be used to charge one of the battery banks 308A, 308B so that the charged battery bank 308A, 308B may be subsequently used to charge the other battery bank 308A, 308B for ice protection.

FIG. 3B is a logical diagram illustrating an ice protection circuit arrangement 320 with the first batteries 302A connected to charge the second batteries 302B according to some embodiments. This arrangement has the batteries 302A, 302B with a direction of the charging that is the reverse of that in the arrangement shown in FIG. 3A. Changing the battery bank 308A, 308B that is charging and that is being charged is an example of the matrixing that may be performed to generate the heat needed to provide effective ice protection.

FIG. 3C is a logical diagram illustrating an ice protection circuit arrangement 340 with the second battery bank 308B connected to a vehicle power source 310 according to some embodiments. When the useful energy in the system is nearing depletion, one of the battery banks 308A, 308B may be recharged from a vehicle power system 310, such as aircraft generators, or the like. For example, the second batteries 302B of the second battery bank 308B may be charged, if necessary, to extend the useful operational time of the system by providing additional charge to the second battery bank 308B. This will allow the crew to arbitrarily extend the use of the system if icing conditions persist for longer than expected, and one of the battery banks 308A, 308B may be recharged multiple times. Additionally, the combination of individual batteries that make up the first battery bank 308A or second battery bank 308B may be changed dynamically as necessary.

In some embodiments, a controller may connect a battery bank 308A, 308B to vehicle power source 310 or an external power source 312 by selectively activating charging switches 314 to connect a selected battery bank 308A, 308B to the selected power source. Additionally, a battery bank 308A, 308B a that is not being charged may be isolated by the controller by deactivating one or more isolation switches 316. For example, the second battery bank 308B may be connected to the vehicle power source 310 by activating the relevant charging switches 314, and the first battery bank 308A may be isolated from the vehicle power source 310 and the second battery bank 308B by deactivating, disconnecting, or turning off the isolation switches 316. Additionally, while the relevant circuitry is not shown, the first battery bank 308A may be connected to the vehicle power source 310 and the second battery bank 308B isolated from the first battery bank and from the vehicle power source 310. It should be understood that the battery banks 308A, 308B may be selectively connected to an external power source 312, or to another power source such as a backup battery or the like to charge one or more of the battery banks 308A, 308B. For example, one of the battery banks 308A, 308B may be charged from the external power source 312 while on the ground, and may be charged from the vehicle power source 310 while underway.

FIG. 3D is a logical diagram illustrating an ice protection circuit arrangement 360 with the second battery bank 308B having multiple battery groups 362A, 362B connected in parallel to charge the first battery bank 308A according to some embodiments. A controller may matrix batteries within a battery bank 308A, 308B to adjust or customize the voltage and current being provided to another battery bank 308A, 308B to increase the charge current or charge voltage, thereby controlling the rate of heat generation. This, in some embodiments, batteries within a battery bank 308A, 308B may be connected into smaller series groups 362A, 362B that are connected in parallel. This lowers the overall voltage being applied to another battery bank 308A, 308B, but increases the available current. For example, where the first battery bank 308A is charging the second battery bank 308B, first batteries 302A may be connected in series, and the second batteries 302B may be connected to form multiple battery groups 362A, 362B, with, for example, two second batteries 302B in series in first battery group 362A and two batteries in a second battery group 362B, and with the battery groups 362A, 362B connected in parallel. Thus, each battery group 362A, 362B has a voltage that is double the voltage of a single battery, but would have a voltage lower than the overall voltage of the first batter bank 308A. The battery groups 362A 3623 having a total voltage lower than the voltage of the first battery bank 308A, permits the first battery bank 308A to charge each of the battery groups 362A, 362B.

In some embodiments, a controller is connected to switches 306A, 306B, 304A, 314 to control the charging of batteries 302A, 302, and connection arrangements of the batteries 302A, 302B. A controller may be configured to control connections between batteries 302A via, for example, first series switches 306A or by controlling the switching duration by controlling how long the cell being charged is exposed to the much higher voltage source to prevent a cell from exceeding its overvoltage limit or overtemperature limit. Such a controller may omit a DC-DC converter or other voltage regulation device would only be able to prevent a cell from exceeding its overvoltage limit or overtemperature limit by controlling the switching duration (how long the cell being charged is exposed to the much higher voltage source). Additionally, the first series switches 306A may, in some embodiments, be used to separate the batteries 302A into different sized groups, such as 1 cell groups, 2 cell groups, or another grouping or arrangement of batteries 302A.

FIG. 4 is a logical diagram illustrating an ice protection circuit 400 according to some embodiments. The circuit 400 may include a controller 410 that has, for example, a processor and a non-transitory computer readable medium storing a computer program or software for implementing an ice protection method or a de-icing process according to some embodiments. The computer program or software may include instructions for controlling a switching system 404 to connect first batteries a group of batteries 402 to charge second batteries of the group of batteries 402 to generate heat for melting ice on a surface of a body or element containing the batteries 402.

In some embodiments, the controller 410, or individual elements or subsystems thereof may be implemented on one or more computer systems, for example, using standalone computers, one or more servers, and/or cloud computing resources or systems. Thus, the ice protection circuit 400 or a subsystem may have one or more processors and one or more non-transitory computer readable memory or media, which may store computer program code for implementing functionality of the system.

References to computer-readable storage medium, computer program product, tangibly embodied computer program, or the like, or a controller, display system, computer, processor, or the like should be understood to encompass not only computers having different architectures such as single or multi-processor architectures and sequential (Von Neumann) or parallel architectures but also specialized circuits such as field-programmable gate arrays (FPGAs), application specific circuits (ASICs), signal processing devices and other devices. References to computer program, instructions, code, or the like, should be understood to encompass software for a programmable processor or firmware such as, for example, the programmable content of a hardware device, whether instructions for a processor, or configuration settings for a fixed-function device, gate array or programmable logic device, or the like. In other embodiments, the controller may be a system or circuit that employs a digital or analog proportional-integral- derivative (PID) control loop, a bang-bang controller, a feedback system, or the like.

The system may have at least one processor and at least one memory, such as a non-transitory computer readable medium, and may include computer program code, that is configured to, with the at least one processor, provide the actuator disengagement pressure testing. The memory may be a single component or, may be implemented as one or more separate components, some or all of which may be integrated or removable and may provide permanent, semi-permanent, dynamic, or cached storage.

The one or more processors are configured to read from and write to the at least one memory. The processor may also comprise an output interface via which data or commands are output by the processor and an input interface via which data or commands are input to the processor. The memory stores a computer program including computer program instructions that control the operation, when loaded into the processor, of the overall ice protection circuit 400, the controller, or other elements, such as the switching system 404, or the like. The computer program instructions provide the logic and routines that enable the apparatus to perform the de-icing and battery charging/discharging management and control, and the like. The processor, by reading the memory, is able to load and execute the computer program. The computer program or programs may arrive at the apparatus via any suitable delivery mechanism. The delivery mechanism may be, for example, a computer-readable storage medium, a computer program product, a memory device, a record medium such as a compact disc read only memory (CD-ROM), digital versatile disc (DVD), portable memory such as a memory stick or hard drive, or the like, an article of manufacture that tangibly embodies the computer program. In some embodiments, the delivery mechanism may be a signal configured to reliably transfer the computer program over the air or via an electrical or optical connection. The controller 410 enables or disables the ice protection system using the ice protection circuit 400 and controls heating of the zones via charging of different batteries 402. This may include using the switching system 404 to enable or disable the charging of batteries 402 from an aircraft or vehicle power system 414, or from external power system 416 or power source. The controller 410 may perform first switching control by generating control signals that control the switching system 414 to connect at least one first battery to at least one second battery in an arrangement causing the at least one first battery to discharge by charging the at least one second battery. The at least one first battery discharging by charging the at least one second battery heats the exterior surface and at least one of melts an ice accretion on the exterior surface or prevents accretion of ice on the exterior surface. Similarly, the controller 410 may further perform second switching control by controlling the switching system 414 to connect the at least one second battery to the at least one first battery in an arrangement causing the at least one second battery to discharge by charging the at least one second battery. The at least one second battery discharging by charging the at least one first battery heats the exterior surface and melts or prevents ice on the exterior surface. In some embodiments, the controller 410 may alternative between the first switching control and the second switching control to melt or prevent ice on the exterior surface.

In some embodiments, the ice protection circuit 400 may be part of a system for a leading-edge wing ice protection, and the controller 410 may be at least two controllers 410 installed in the aircraft, with each controlling alternating ice protection zones on each wing. This creates redundancy and independence in ice protection, preventing a fault in a single controller 410 from rendering the entire ice protection system inoperative.

The ice protection circuit 400 may include one or more temperature sensors 408 that gather temperature data on battery temperatures, surface temperatures, or the like, that indicates the temperature state of the batteries 402 or temperature state of an exterior surface or other structure, and that indicates whether the heat being produced by the batteries 402 is sufficient to perform the desired ice protection. In some embodiments, the temperature sensors may be resistance temperature detector (RTDs), thermistors, or the like, and may be included in the leading-edge composite stackup forming the batteries 402.

Additionally, the circuit 400 may have a voltage management system 406 that monitors the operating parameters, such as voltage, charge state performance, electrical status, and the like, of the batteries 402. The controller 410 may receive voltage management data from the voltage management system 406 indicating the operating parameters of the batteries 402, and may control the switching system 404, and consequently, the charging of the batteries 402, based on the operating parameters. The controller 410 may use a simple closed-loop control to keep the temperature of the leading-edge of the surface within a predetermined range by enabling and disabling the transfer of charge between batteries 402 within the leading-edge MFC. In some embodiments, the controller 410 may modulates, controls, handles, manages, or otherwise changes the connection state of battery banks based on the charge state of batteries 402. For example, when the controller is performing the first switching control where the first batteries or a first battery bank discharges to charge a second battery bank, the controller 410 may monitor the charge state of the first battery bank, and when the first battery bank is discharged below a discharge threshold, the controller 410 may switch to performing second switching control where the second battery bank is connected to discharge by charging the first battery bank.

The controller 410 may receive an activation signal from an operator control 412, an automated system, or from another source. For example, the controller 410 may turn on the ice protection system in response to a pilot of an aircraft pushing a switch or otherwise activating an operator control 412, with the operator control 412 generating the activation signal indicating that the ice protection system should be active. The controller 410 may then determine the temperature of the leading edge and charge or voltage of the batteries 402 based on sensor signals from the temperature sensors 408 and voltage management system 406.

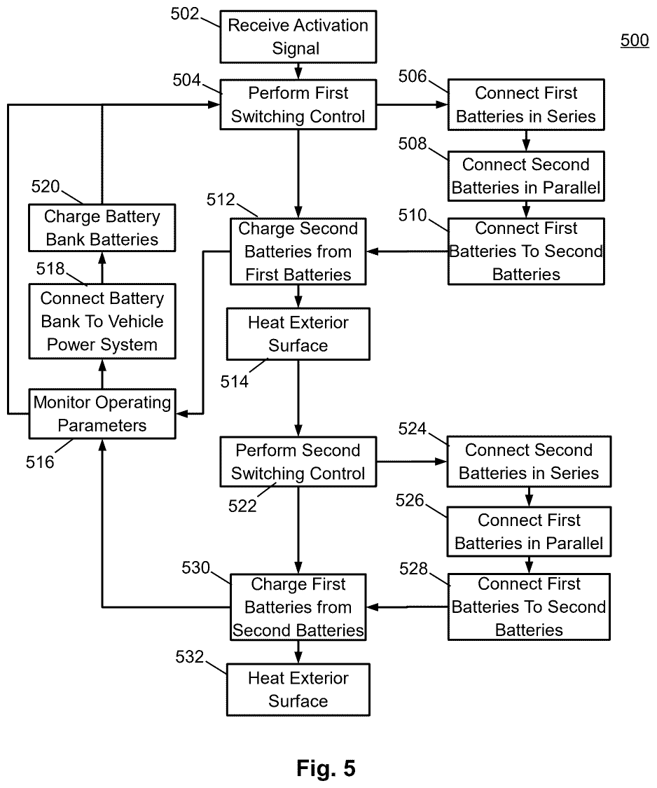

FIG. 5 is a flow diagrams illustrating a method 500 for using ice protection systems according to some embodiments. In block 502, the system may receive an activation signal. The activation signal may be, for example, a signal from a pilot or other user, to engage the ice protection system. In other embodiments, the activation signal may be a signal from an automated system that monitors exterior conditions such as precipitation, temperature, ice accumulation, or the like, and automatically turns on or engages the ice protection system.

In block 504, first switching control is performed. In some embodiments, a controller controls the switching system to connect at least one first battery to at least one second battery in an arrangement causing the at least one first battery to discharge by charging, in block 512, the at least one second battery.

In some embodiments, the first switching control comprises the controller causing the switching system, in block 506, to connect first batteries in series with each other, to connect, in block 508, second batteries in parallel with each other, and, to connect, in block 510, the first batteries to the second batteries. In some embodiments, connecting the first batteries to the second batteries comprises connecting first terminals of the first batteries to first terminals of the second batteries and connecting second terminals of the first batteries to second terminals of the second batteries. After the first batteries are connected to the second batteries, the second batteries, in block 512, are charged by the first batteries.

The at least one first battery is disposed adjacent to an exterior surface of a vehicle, and the at least one second battery is electrically connectable to the at least one first battery and is adjacent to the exterior surface. In block 514, the at least one first battery discharging by charging the at least one second battery heats the exterior surface, and of melts or prevents accretion of ice on the exterior surface. In some embodiments, parts of one first battery and second battery are paired and in separate physical areas so that if one pair of batteries fails, the failed pair does not completely take out one zone on the leading edge.

In block 522, second switching control is performed. In some embodiments, a controller controls the switching system to connect at least one second battery to at least one first battery in an arrangement causing the at least one second battery to discharge by charging, in block 530, the at least one first battery.

In some embodiments, the second switching control comprises the controller causing the switching system, in block 524, to connect second batteries in series with each other, to connect, in block 526, first batteries in parallel with each other, and, to connect, in block 532, the second batteries to the first batteries. In some embodiments, connecting the second batteries to the first batteries comprises connecting first terminals of the first batteries to first terminals of the second batteries and connecting second terminals of the first batteries to second terminals of the second batteries. After the second batteries are connected to the first batteries, the first batteries, in block 530, are charged by the second batteries. In block 532, the at least one second battery discharging by charging the at least one first battery heats the exterior surface, and of melts or prevents accretion of ice on the exterior surface.

In some embodiments, the system performs the heating of the exterior surface in block 514 and 532 by alternating between the first switching control in block 504 and the second switching control in block 522. The process may be repeated, with alternate groups of batteries being charged and discharged to maintain a desired temperature on the exterior surface and protect the exterior surface from ice accumulation. The heating the exterior surface by alternating between the first switching control and the second switching control may, in some embodiments, include heating the exterior surface by at least one of alternating between performing the first switching control and performing the second switching control according to the temperature data, or controlling a rate of charge between the at least one first battery and the at least one second battery according to temperature data from temperature sensors associated with an exterior surface.

In some embodiments, while, or after, the second batteries are charged by the first batteries in block 512, or the first batteries are charged by the second batteries in block 530, a system, such as a controller, may monitor, in block 516, operating parameters of at least one first battery and at least one second battery. The heating, by alternating between the first switching control and the second switching control, the exterior surface, may in some embodiments, comprise heating the exterior surface by alternating between performing the first switching control and performing the second switching control according to the operating parameters. Additionally, in some embodiments, the operating parameters comprises a charge state of the at least one first battery and the at least one second battery, and the system may, in block 518 cause the switching system to connect the at least one first battery, or a battery bank with the first battery, to a vehicle power system according to the charge state. Additionally, the at least one second battery, or a second battery bank including the second battery, may be isolated by the controller, with the switching system isolating the at least one second battery, or second battery bank, from the at least one first battery and from the vehicle power system. In block 520, the battery bank or the first battery may be charged as a result of being connected to the vehicle power system. The charging the at least one first battery from the vehicle power system and the isolating the at least one second battery may, in some embodiments, be performed in response to a voltage of any of the at least one first battery or the at least one second battery falling below a threshold.

An ice protection system, including at least one first multifunctional composite (MFC) battery cell disposed at an exterior surface of a vehicle, at least one second MFC battery cell disposed at the exterior surface, a switching system connected to the at least one first MFC battery cell and the at least one second MFC battery cell, and at least one controller, configured for performing first switching control by controlling the switching system to connect the at least one first MFC battery cell to the at least one second MFC battery cell in an arrangement causing the at least one first MFC battery cell to discharge by charging the at least one second MFC battery cell, where the at least one first MFC battery cell discharging by charging the at least one second MFC battery cell heats the exterior surface and at least one of melts an ice accretion on the exterior surface or prevents accretion of ice on the exterior surface.

In some embodiments, the controller is further configured for performing second switching control by controlling the switching system to connect the at least one second MFC battery cell to the at least one first MFC battery cell in an arrangement causing the at least one second MFC battery cell to discharge by charging the at least one first MFC battery cell, where the at least one second MFC battery cell discharging by charging the at least one first MFC battery cell heats the exterior surface and at least one of melts an ice accretion on the exterior surface or prevents accretion of ice on the exterior surface. In some embodiments, the controller is further configured for heating, by alternating between the first switching control and the second switching control, the exterior surface and at least one of melting an ice accretion on the exterior surface or preventing accretion of ice on the exterior surface. In some embodiments, the system further includes a voltage management system configured to monitor operating parameters of the at least one first MFC battery cell and the at least one second MFC battery cell, and where the controller being configured for heating, by alternating between the first switching control and the second switching control, the exterior surface, includes the controller being configured for heating the exterior surface by alternating between performing the first switching control and performing the second switching control according to the operating parameters. In some embodiments, the system further includes one or more temperature sensors configured to generate temperature data associated with the exterior surface, and where the controller being configured for heating, by alternating between the first switching control and the second switching control, the exterior surface, includes the controller being configured for heating the exterior surface by at least one of alternating between performing the first switching control and performing the second switching control according to the temperature data, or controlling a rate of charge between the at least one first MFC battery cell and the at least one second MFC battery cell according to the temperature data. In some embodiments, the at least one first MFC battery cell includes a plurality of first MFC battery cells, and the at least one second MFC battery cell includes a plurality of second MFC battery cells, where the controller being configured for performing the first switching control includes the controller being configured for causing the switching system to connect first MFC battery cells of the plurality of first MFC battery cells in series, and causing the switching system to connect second MFC battery cells of the plurality of second MFC battery cells in parallel, and causing the switching system to connect first ends of the first MFC battery cells to first ends of the second MFC battery cells and to connect second ends of the first MFC battery cells in series to second ends of the second MFC battery cells, and where the controller being configured for performing the second switching control includes the controller being configured for causing the switching system to connect the second MFC battery cells in series, and causing the switching system to connect the first MFC battery cells of the plurality of first MFC battery cells in parallel. In some embodiments, the exterior surface is a leading edge of a wing of an aircraft, and where the first MFC battery cells are arranged to have a placement that alternates with placement of the second MFC battery cells along the leading edge, and with an arrangement direction following the leading edge.

An embodiment ice protection method includes performing, by a controller, first switching control by controlling a switching system to connect at least one first multifunction composite (MFC) battery cell to at least one second MFC battery cell in an arrangement causing the at least one first MFC battery cell to discharge by charging the at least one second MFC battery cell, where the at least one first battery is disposed adjacent to an exterior surface of a vehicle, where the at least one second MFC battery cell is disposed adjacent to the at least one first MFC battery cell and adjacent to the exterior surface, where the at least one first MFC battery cell discharging by charging the at least one second MFC battery cell heats the exterior surface by transferring, to the exterior surface, heat generated in a body of the at least one first MFC battery cell or the at least one second MFC battery cell as a result of the discharging or charging, where the transferring the heat at least one of melts an ice accretion on the exterior surface or prevents accretion of ice on the exterior surface.

In some embodiments, the method further includes performing, by the controller, second switching control by controlling the switching system to connect the at least one second MFC battery cell to the at least one first MFC battery cell in an arrangement causing the at least one second MFC battery cell to discharge by charging the at least one second MFC battery cell, where the at least one second MFC battery cell discharging by charging the at least one first MFC battery cell heats the exterior surface and at least one of melts an ice accretion on the exterior surface or prevents accretion of ice on the exterior surface, and heating, by alternating between the first switching control and the second switching control, the exterior surface and at least one of melting an ice accretion on the exterior surface or preventing accretion of ice on the exterior surface. In some embodiments, the method further includes monitoring operating parameters of the at least one first MFC battery cell and the at least one second MFC battery cell, and where the heating, by alternating between the first switching control and the second switching control, the exterior surface, includes heating the exterior surface by alternating between performing the first switching control and performing the second switching control according to the operating parameters. In some embodiments, the operating parameters of the at least one first MFC battery cell and the at least one second MFC battery cell includes a charge state of the at least one first MFC battery cell and the at least one second MFC battery cell, and where the method further includes performing, according to the charge state charging the at least one first MFC battery cell by causing, by the controller, the switching system to connect the at least one first MFC battery cell to a vehicle power system, and isolating the at least one second MFC battery cell by causing, by the controller, the switching system to isolate the at least one second MFC battery cell from the at least one first MFC battery cell and from the vehicle power system. In some embodiments, the charging the at least one first MFC battery cell and the isolating the at least one second MFC battery cell are performed in response to a voltage of any of the at least one first MFC battery cell or the at least one second MFC battery cell falling below a threshold. In some embodiments, the method further includes generating temperature data associated with the exterior surface, and the heating, by alternating between the first switching control and the second switching control, the exterior surface, includes heating the exterior surface by at least one of alternating between performing the first switching control and performing the second switching control according to the temperature data, or controlling a rate of charge between the at least one first MFC battery cell and the at least one second MFC battery cell according to the temperature data. In some embodiments, the at least one first MFC battery cell includes a plurality of first MFC battery cells, and the at least one second MFC battery cell includes a plurality of second MFC battery cells, where the performing the first switching control includes causing, by the controller, the switching system to connect, in series, first MFC battery cells of the plurality of first MFC battery cells, and causing, by the controller, the switching system to connect, in parallel, second MFC battery cells of the plurality of second MFC battery cells, and causing, by the controller, the switching system to connect first terminals of the first MFC battery cells to first terminals of the second MFC battery cells and to connect second terminals of the first MFC battery cells to second terminals of the second MFC battery cells, and where the performing the second switching control includes causing the switching system to connect the second MFC battery cells in series, and causing the switching system to connect the first MFC battery cells in parallel, and causing the switching system to connect first terminals of the plurality of first MFC battery cells to first terminals of the plurality of second MFC battery cells and to connect second terminals of the first MFC battery cells to second terminals of the plurality of second MFC battery cell.

An embodiment system includes an ice protection system disposed at a vehicle exterior surface, the ice protection system including a plurality of first a multifunction composite (MFC) battery cell disposed adjacent to an exterior surface of the vehicle exterior surface,, a plurality of second MFC battery cells disposed adjacent to the exterior surface, where the second MFC battery cells of the plurality of second MFC battery cells are each an MFC, where the first MFC battery cells are disposed in a stack, along a leading edge of the vehicle exterior surface, alternating with the second MFC battery cells, and with an arrangement direction that is substantially parallel to the leading edge, and a switching system connected to each of the first MFC battery cells and to each of the second MFC battery cells, where the switching system has first circuitry adapted to connect, in response to at least one first control signal, the first MFC battery cells to the second MFC battery cells in a first arrangement causing the first MFC battery cells to discharge by charging the second MFC battery cells, where the first MFC battery cells discharging by charging the second MFC battery cells heat the exterior surface to provide the ice protection, and where the switching system further has second circuitry adapted to switch, in response to at least one second control signal, the first MFC battery cells and the second MFC battery cells from being connected in the first arrangement to being connected in a second arrangement causing the second MFC battery cells to discharge by charging the first MFC battery cells, where the second MFC battery cells discharging by charging the first MFC battery cells heat the exterior surface to further provide the ice protection.

In some embodiments, the system further includes a voltage management system configured to generate monitoring data indicating operating parameters of the first MFC battery cells and the second MFC battery cells, and to provide the monitoring data to one or more controllers, and where the at least one second control signal is associated with the monitoring data. In some embodiments, the first arrangement includes the first MFC battery cells being connected to each other in series, and further includes the second MFC battery cells being connected to each other in parallel, and further includes first terminals of the first MFC battery cells being connected to first terminals of the second MFC battery cells and further includes second terminals of the first MFC battery cells being connected to second terminals of the second MFC battery cells, and where the second arrangement includes the first MFC battery cells being connected to each other in parallel, and further includes the second MFC battery cells being connected to each other in series, and further includes first terminals of the first MFC battery cells being connected to first terminals of the second MFC battery cells and further includes second terminals of the first MFC battery cells being connected to second terminals of the second MFC battery cells. In some embodiments, the switching system has third circuitry adapted to connect, in response to at least one third control signal, a first MFC battery cell bank having a one of the first MFC battery cells or the second MFC battery cells to a vehicle power system in a third arrangement causing the vehicle power system to charge the first MFC battery cell bank, and further causing a second MFC battery cell bank having another one of the first MFC battery cells or the second MFC battery cells to be isolated from the first MFC battery cell bank and from the vehicle power system. In some embodiments, each of the first MFC battery cells and each of the second MFC battery cells include arcuate electrodes. In some embodiments, each of the first MFC battery cells and each of the second MFC battery cells include electrodes disposed in an arrangement direction extending along the leading edge.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An ice protection system, comprising:
at least one first multifunctional composite (MFC) battery cell disposed at an exterior surface of a vehicle;
at least one second MFC battery cell disposed at the exterior surface;
a switching system connected to the at least one first MFC battery cell and the at least one second MFC battery cell; and
at least one controller, configured for performing first switching control by controlling the switching system to connect the at least one first MFC battery cell to the at least one second MFC battery cell in an arrangement causing the at least one first MFC battery cell to discharge by charging the at least one second MFC battery cell, wherein the at least one first MFC battery cell discharging by charging the at least one second MFC battery cell heats the exterior surface and at least one of melts an ice accretion on the exterior surface or prevents accretion of ice on the exterior surface.

2. The system of claim 1, wherein the controller is further configured for:
performing second switching control by controlling the switching system to connect the at least one second MFC battery cell to the at least one first MFC battery cell in an arrangement causing the at least one second MFC battery cell to discharge by charging the at least one first MFC battery cell, wherein the at least one second MFC battery cell discharging by charging the at least one first MFC battery cell heats the exterior surface and at least one of melts an ice accretion on the exterior surface or prevents accretion of ice on the exterior surface.

3. The system of claim 2, wherein the controller is further configured for:
heating, by alternating between the first switching control and the second switching control, the exterior surface and at least one of melting an ice accretion on the exterior surface or preventing accretion of ice on the exterior surface.

4. The system of claim 3, further comprising a voltage management system configured to monitor operating parameters of the at least one first MFC battery cell and the at least one second MFC battery cell; and
wherein the controller being configured for heating, by alternating between the first switching control and the second switching control, the exterior surface, comprises the controller being configured for heating the exterior surface by alternating between performing the first switching control and performing the second switching control according to the operating parameters.

5. The system of claim 3, further comprising one or more temperature sensors configured to generate temperature data associated with the exterior surface; and
wherein the controller being configured for heating, by alternating between the first switching control and the second switching control, the exterior surface, comprises the controller being configured for heating the exterior surface by at least one of alternating between performing the first switching control and performing the second switching control according to the temperature data, or controlling a rate of charge between the at least one first MFC battery cell and the at least one second MFC battery cell according to the temperature data.

6. The system of claim 2, wherein the at least one first MFC battery cell comprises a plurality of first MFC battery cells, and wherein the at least one second MFC battery cell comprises a plurality of second MFC battery cells;
wherein the controller being configured for performing the first switching control comprises the controller being configured for:
causing the switching system to connect first MFC battery cells of the plurality of first MFC battery cells in series; and
causing the switching system to connect second MFC battery cells of the plurality of second MFC battery cells in parallel; and
causing the switching system to connect first ends of the first MFC battery cells to first ends of the second MFC battery cells and to connect second ends of the first MFC battery cells in series to second ends of the second MFC battery cells; and
wherein the controller being configured for performing the second switching control comprises the controller being configured for:
causing the switching system to connect the second MFC battery cells in series; and
causing the switching system to connect the first MFC battery cells of the plurality of first MFC battery cells in parallel.

7. The system of claim 6, wherein the exterior surface is a leading edge of a wing of an aircraft; and
wherein the first MFC battery cells are arranged to have a placement that alternates with placement of the second MFC battery cells along the leading edge, and with an arrangement direction following the leading edge.

8. An ice protection method, comprising:
performing, by a controller, first switching control by controlling a switching system to connect at least one first multifunction composite (MFC) battery cell to at least one second MFC battery cell in an arrangement causing the at least one first MFC battery cell to discharge by charging the at least one second MFC battery cell, wherein the at least one first battery is disposed adjacent to an exterior surface of a vehicle, wherein the at least one second MFC battery cell is disposed adjacent to the at least one first MFC battery cell and adjacent to the exterior surface, wherein the at least one first MFC battery cell discharging by charging the at least one second MFC battery cell heats the exterior surface by transferring, to the exterior surface, heat generated in a body of the at least one first MFC battery cell or the at least one second MFC battery cell as a result of the discharging or charging, wherein the transferring the heat at least one of melts an ice accretion on the exterior surface or prevents accretion of ice on the exterior surface.

9. The method of claim 8, further comprising:
performing, by the controller, second switching control by controlling the switching system to connect the at least one second MFC battery cell to the at least one first MFC battery cell in an arrangement causing the at least one second MFC battery cell to discharge by charging the at least one second MFC battery cell, wherein the at least one second MFC battery cell discharging by charging the at least one first MFC battery cell heats the exterior surface and at least one of melts an ice accretion on the exterior surface or prevents accretion of ice on the exterior surface; and
heating, by alternating between the first switching control and the second switching control, the exterior surface and at least one of melting an ice accretion on the exterior surface or preventing accretion of ice on the exterior surface.

10. The method of claim 9, further comprising monitoring operating parameters of the at least one first MFC battery cell and the at least one second MFC battery cell; and
wherein the heating, by alternating between the first switching control and the second switching control, the exterior surface, comprises heating the exterior surface by alternating between performing the first switching control and performing the second switching control according to the operating parameters.

11. The method of claim 10, wherein the operating parameters of the at least one first MFC battery cell and the at least one second MFC battery cell comprises a charge state of the at least one first MFC battery cell and the at least one second MFC battery cell; and
wherein the method further comprises performing, according to the charge state:
charging the at least one first MFC battery cell by causing, by the controller, the switching system to connect the at least one first MFC battery cell to a vehicle power system; and
isolating the at least one second MFC battery cell by causing, by the controller, the switching system to isolate the at least one second MFC battery cell from the at least one first MFC battery cell and from the vehicle power system.

12. The method according to claim 11, wherein the charging the at least one first MFC battery cell and the isolating the at least one second MFC battery cell are performed in response to a voltage of any of the at least one first MFC battery cell or the at least one second MFC battery cell falling below a threshold.

13. The method of claim 9, further comprising generating temperature data associated with the exterior surface; and
wherein the heating, by alternating between the first switching control and the second switching control, the exterior surface, comprises heating the exterior surface by at least one of alternating between performing the first switching control and performing the second switching control according to the temperature data, or controlling a rate of charge between the at least one first MFC battery cell and the at least one second MFC battery cell according to the temperature data.

14. The method of claim 8, wherein the at least one first MFC battery cell comprises a plurality of first MFC battery cells, and wherein the at least one second MFC battery cell comprises a plurality of second MFC battery cells;
wherein the performing the first switching control comprises:
causing, by the controller, the switching system to connect, in series, first MFC battery cells of the plurality of first MFC battery cells; and
causing, by the controller, the switching system to connect, in parallel, second MFC battery cells of the plurality of second MFC battery cells; and
causing, by the controller, the switching system to connect first terminals of the first MFC battery cells to first terminals of the second MFC battery cells and to connect second terminals of the first MFC battery cells to second terminals of the second MFC battery cells ; and
wherein the performing the second switching control comprises:
causing the switching system to connect the second MFC battery cells in series; and
causing the switching system to connect the first MFC battery cells in parallel; and
causing the switching system to connect first terminals of the plurality of first MFC battery cells to first terminals of the plurality of second MFC battery cells and to connect second terminals of the first MFC battery cells to second terminals of the plurality of second MFC battery cell.

15. A system, comprising:
an ice protection system disposed at a vehicle exterior surface, the ice protection system comprising:
a plurality of first a multifunction composite (MFC) battery cell disposed adjacent to an exterior surface of the vehicle exterior surface;
a plurality of second MFC battery cells disposed adjacent to the exterior surface, wherein the second MFC battery cells of the plurality of second MFC battery cells are each an MFC, wherein the first MFC battery cells are disposed in a stack, along a leading edge of the vehicle exterior surface, alternating with the second MFC battery cells, and with an arrangement direction that is substantially parallel to the leading edge; and
a switching system connected to each of the first MFC battery cells and to each of the second MFC battery cells;
wherein the switching system has first circuitry adapted to connect, in response to at least one first control signal, the first MFC battery cells to the second MFC battery cells in a first arrangement causing the first MFC battery cells to discharge by charging the second MFC battery cells, wherein the first MFC battery cells discharging by charging the second MFC battery cells heat the exterior surface to provide the ice protection; and
wherein the switching system further has second circuitry adapted to switch, in response to at least one second control signal, the first MFC battery cells and the second MFC battery cells from being connected in the first arrangement to being connected in a second arrangement causing the second MFC battery cells to discharge by charging the first MFC battery cells, wherein the second MFC battery cells discharging by charging the first MFC battery cells heat the exterior surface to further provide the ice protection.

16. The system of claim 15, further comprising a voltage management system configured to generate monitoring data indicating operating parameters of the first MFC battery cells and the second MFC battery cells, and to provide the monitoring data to one or more controllers; and
wherein the at least one second control signal is associated with the monitoring data.

17. The system of claim 15, wherein the first arrangement comprises the first MFC battery cells being connected to each other in series, and further comprises the second MFC battery cells being connected to each other in parallel, and further comprises first terminals of the first MFC battery cells being connected to first terminals of the second MFC battery cells and further comprises second terminals of the first MFC battery cells being connected to second terminals of the second MFC battery cells; and
wherein the second arrangement comprises the first MFC battery cells being connected to each other in parallel, and further comprises the second MFC battery cells being connected to each other in series, and further comprises first terminals of the first MFC battery cells being connected to first terminals of the second MFC battery cells and further comprises second terminals of the first MFC battery cells being connected to second terminals of the second MFC battery cells.

18. The system of claim 15, wherein the switching system has third circuitry adapted to connect, in response to at least one third control signal, a first MFC battery cell bank having a one of the first MFC battery cells or the second MFC battery cells to a vehicle power system in a third arrangement causing the vehicle power system to charge the first MFC battery cell bank, and further causing a second MFC battery cell bank having another one of the first MFC battery cells or the second MFC battery cells to be isolated from the first MFC battery cell bank and from the vehicle power system.

19. The system according to claim 15, wherein each of the first MFC battery cells and each of the second MFC battery cells comprise arcuate electrodes.

20. The system according to claim 15, wherein each of the first MFC battery cells and each of the second MFC battery cells comprise electrodes disposed in an arrangement direction extending along the leading edge.
